(19) United States
(12) Patent Application Publication
(10) Pub. No.: US 2015/0339474 A1
(43) Pub. Date: Nov. 26, 2015

(54) USER AUTHENTICATION SYSTEM

(71) Applicant: CELL BUDDY NETWORK LTD., Tel Aviv (IL)

(72) Inventors: Ofir PAZ, Rishon Lezion (IL); Yossi DAGAN, Kfar Saba (IL); Erez DORON, Tel Aviv (IL); Simcha ARONSON, Raanana (IL)

(21) Appl. No.: 14/654,844

(22) PCT Filed: Dec. 24, 2013
(86) PCT No.: PCT/IB13/61312

§ 371 Date: Jun. 23, 2015

Related U.S. Application Data
(60) Provisional application No. 61/745,716, filed on Dec. 24, 2012.

(51) Int. Cl. G06F 21/34; H04L 9/32; H04W 12/06; G06F 21/35

(52) U.S. Cl. CPC G06F 21/34; G06F 21/35; H04L 9/3234; H04L 9/3226; H04W 12/06

(57) ABSTRACT

A method of authenticating a user to each of a plurality of services provided by at least one service provider, the method comprising: providing the user with a smart card having stored therein a plurality of authentication keys and comprising communication circuitry for communicating with a communication device that the user uses to communicate with the at least one service provider; and communicating with the smart card to authenticate the user responsive to an authentication key of the plurality of authentication keys.

### RELATED APPLICATIONS

The present application claims the benefit under 35 U.S.C. 119(e) of U.S. Provisional Applications 61/745,716 filed on Dec. 24, 2012, the disclosure of which is incorporated herein by reference.

### FIELD

Embodiments of the invention relate to user authentication.

### BACKGROUND

Present day communication networks, their various configurations, and devices available for accessing the communication networks, support a plethora of user options for communication with others and accessing a host of different business, information, and entertainment services. Familiar services that service providers offer over today's communication networks include, to name a few by way of example: voice and data transmission; financial and banking services that provide access to and control of personal banking and investment accounts; information services; on-line purchasing services that provide access to vendors; email; voice and video conferencing; social networking; and cloud computing and data storage. A user may connect to and access these services via the communication networks using any of a myriad of user communication devices, such as by way of example, a smartphone, laptop, tablet, and desktop computer configured to communicate via the internet or a mobile phone network. A service provider is understood to comprise any hardware or software components necessary to provide services that it offers and communicate with users who use the services.

In many instances a user is allowed access to and use of a service provided by a service provider only after the user has authenticated his or her identity to the service provider. Various authentication procedures and methods exist and may for example, require a user to provide a user name and an associated password, provide a message encrypted using a secret key, and/or engage in a challenge response sequence. For example, mobile phone networks connect a user smartphone to network services only after engaging the smartphone in a challenge response sequence of communications in which a smartphone requesting connection to a mobile phone network receives a challenge from the network. A response to the challenge is generated by a subscriber identity module (SIM) housed in the smartphone using an authentication keyword, referred to as a “KI”. The authentication keyword is configured in the SIM hardware and is generally not accessible from the SIM.

A given user typically uses and interacts with a plurality of different services each requiring user authentication before providing access to the service, and may at different times access these services using different user communication devices.

### SUMMARY

An aspect of the invention relates to providing a system, hereinafter referred to as an “authenticator system” that provides user communication devices with a plurality of authentication procedures that may be used to provide authentication for access to a plurality of different services.

In an embodiment of the invention, the authenticator system comprises a computer system, and for each user, of the authenticator system a user authenticator smart card. The authenticator smart card is configured to communicate with the computer system and at least one user communication device that a user may use to access a service via a communication network. Communication between the authenticator smart card and the at least one communication device may be by a wire and/or a wireless channel. Communication between the smart card and the computer system is at least in part via a wireless channel. Optionally the at least one communication device comprises a smartphone. In an embodiment the authenticator smart card is mounted in or on the smartphone. Optionally, an authenticator smart card mounted in the smartphone is mounted in a socket of the smartphone in which the smartphone SIM (subscriber identity module) or USIM (universal subscriber identity module) card is mounted.

The authenticator smart card has stored, optionally in hardware in the authenticator smart card, a plurality of encryption keys and associated algorithms for generating responses to authentication challenges. The encryption keys and algorithms are optionally similar to encryption keys and algorithms commonly used to authenticate users for access to mobile phone networks. The authenticator computer system is configured to receive requests from a service provider to authenticate identity of a user requesting access to a service provided by the service provider. In response to the request the computer system is configured to engage the user in an authentication procedure that comprises transmitting a challenge to the user's authentication smart card. If the authenticator smart card generates a correct response to the challenge using a stored key and associated algorithm, the computer system transmits a response to the service provider authenticating the user.

In an embodiment of the invention, the authentication procedure comprises at least one communication between the authenticator smart card and a communication device that the user operates to request access to the service. The at least one communication requires active operation of the communication device to provide a response to the request that enables completion of the authentication procedure that results in authentication. In an embodiment of the invention, the computer system, and/or optionally the authenticator smart card, comprises a memory storing information that identifies communication devices that the user may use in accessing a communication network and provider services.

There is therefore provided in accordance with an embodiment of the invention a authenticator system for authenticating identity of a user for access to each of a plurality of services provided by at least one service provider, the authenticator comprising: a smart card having stored therein a plurality of authentication keys and comprising communication circuitry for communicating with a communication device used to communicate with the at least one service provider; and a computer system configured to: receive a communication from a service provider of the at least one service provider comprising a request to authenticate the user when the user operates the communication device to request access to a service provided by the service provider; and communicate with the smart card via the communication device to engage in an authentication process to authenticate identity of the user responsive to an authentication key of the plurality of authentication keys stored in the smart card. Optionally, the smart card is programmed with an executable instruction set for processing the authentication key to engage in the authentication process and authenticate identity of the user.

Optionally the communication circuitry communicates with the communication device via a wireless communication channel. Additionally or alternatively the communication circuitry may communicate with the communication device via a wire communication channel. In an embodiment of the invention upon receiving the communication from the service provider with the request to authenticate the user, the computer system transmits a notice to the communication device that indicates to the user that a request has been made to authenticate the user. Optionally, the notice comprises a request that the user authorize the authentication process. Optionally the authorization includes a request that the user include in a response to the request for authorization a password identifying the user.

In an embodiment of the invention the smart card is programmed with an executable instruction set to implement a blocking algorithm which may be activated to prevent or enable engaging in the authentication process to authenticate identity of the user by transmitting a communication to the communication device.

In an embodiment of the invention the communication device communicates via a mobile phone communication network. In an embodiment of the invention the service provider comprises the computer system. In an embodiment of the invention at least two different services are associated with different authentication keys or at least two different services are associated with a same authentication key.

There is further provided in accordance with an embodiment of the invention, method of authenticating a user to each of a plurality of services provided by at least one service provider, the method comprising: providing the user with a smart card having stored therein a plurality of authentication keys and comprising communication circuitry for communicating with a communication device that the user uses to communicate with the at least one service provider; and communicating with the smart card to authenticate the user responsive to an authentication key of the plurality of authentication keys.

In the discussion, unless otherwise stated, adverbs such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to the figure or figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1 shows a schematic flow diagram of an authentication procedure provided by an authenticator in accordance with an embodiment of the invention.

### DETAILED DESCRIPTION

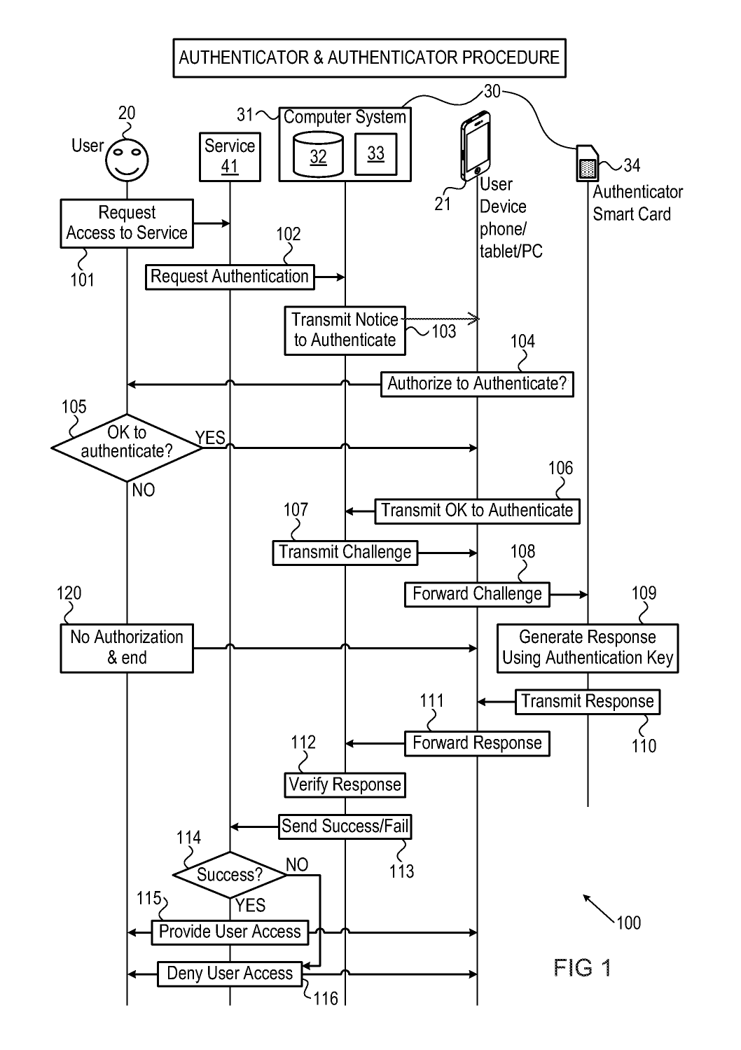

FIG. 1 shows a flow diagram of an authentication procedure 100 provided by an authenticator system 30, in accordance with an embodiment of the invention. Authenticator system 30 comprises a computer system and an authenticator smart card, schematically represented by icons 31 and 34 respectively. Each icon 31 and 34 is appended with a vertical activity line along which their respective activities and statuses during performance of authentication procedure 100 are indicated.

Authenticator system 30 may provide authentication services for a plurality of different users and a plurality of different services that subscribe to authenticator system 30 to have their respective users authenticated for access to their services. Computer system 31 comprises a data base 32 of users and providers subscribed to authenticator system 30 and a processor 33 that processes data in the database to authenticate users for use of services provided by the service providers. Data in database 32 may comprise data identifying users and service providers and encryption keys associated with the users and providers that are used for authenticating users to the service providers. Processor 33 may be programmed with executable instruction sets for processing the encryption keys and communications with users and service providers to perform authentications as described below. The users, service providers, and authenticator system may operate any of various communication devices and use any of various suitable communication networks to communicate with each other.

Each user is issued an authentication smart card, such as authenticator smart card 34, comprising a plurality of authentication keys and associated algorithms for generating responses to challenges the authenticator smart card receives from computer system 31. Computer system 31 transmits challenges to a given authenticator smart card to authenticate identity of a user issued with the given authenticator smart card for use of a service that has subscribed to authenticator system 30 when the user operates a communication device to attempt access to the service. The authenticator smart card is connected to the communication device by a wireless and/or wire communication channel (not shown) over which it receives the challenges and returns responses to the challenges to the computer system. The communication device is programmed by a suitable app, hereinafter also referred to as an authenticator app, to communicate with authenticator smart card 34 over the wire and/or wireless channel or channels, and with computer system 31 via any suitable communication network in authenticating the user.

In flow diagram 100, authenticator system 30 is assumed to be providing authentication services to a user and a service, schematically represented by icons 20 and 41 appended with respective vertical activity lines along which their activities and status during authentication procedure 100 are indicated. User 20 is operating a user communication device schematically represented by an icon 21 and appended activity line to gain access to service provider 41.

Whereas practice of an embodiment of the invention is not limited to mobile phone communication networks nor smartphones, in the discussion that follows it is assumed that user communication device 21 is a smartphone and that a mobile phone network (not shown) operates to connect service provider 41, computer system 31 and user 20. User 20 is assumed to have been authenticated by and connected to the mobile phone network. Authenticator smart card 34 may be comprised in or on smartphone 21 or may be comprised in a housing separate from the smartphone.

In a block 101 a user 20, operates his or her smartphone 21, to request access to a service provided by service provider 41 via the mobile phone network to which user 20 is connected. In a block 102, in response to the request by user 20, service provider 41 optionally sends a request to computer system 31 to authenticate the identity of user 20. Optionally, in a block 103 computer system 31 transmits a notice to smartphone 21 that a request has been made by service provider 41 to authenticate user 20. In a block 104, optionally the authenticator app in smartphone 21 generates a message for user 20 that a notice to authenticate has been received from service provider 41 and that authorization to proceed with authentication is requested by authenticator computer system 31. The message may contain a request that in responding to the request to authorize authentication user 20 operate the smartphone to include a predetermined password as verification as to the user's identity. Optionally, the message comprises a text message and/or popup image presented by smartphone 21. In a decision block 105, user 20 determines whether or not to authorize authentication. If user 20 does not authorize authentication, he or she operates smartphone 21 to respond to the request for authorization and indicate that authorization is not given and authentication procedure 100 optionally proceeds to a block 120 and ends.

If in decision block 105 user 20 determines to authorize authentication, the user operates smartphone 21 to indicate that authorization is given. In response to authorization to proceed with authentication, in a block 106 the smartphone optionally transmits authorization to computer system 31 to authenticate user 20 for access to and use of a service provided by service provider 41. In response to receiving authorization from smartphone 21, in a block 107 computer system 31 optionally transmits an authentication challenge to smartphone 21 for forwarding to authenticator smart card 34. The authentication challenge may also include instructions to the authenticator app in smartphone 21 to present a request to user 20 to transmit a password to computer system 31 to verify the user's identity. It is noted that in an embodiment of the invention, blocks 103-106 may be omitted, and upon receiving a request for authentication in block 102 computer systems 31 may proceed directly to block 107 and transmit a challenge to smartphone 21 for forwarding to authenticator smart card 34.

In a block 108 smartphone 21 forwards the challenge to authenticator smart card 34 over the wire and/or wireless channel that connects the smartphone and authenticator smart card. In a block 109 authenticator smart card 34 optionally generates a response to the challenge using an authorization key of the plurality of authorization keys stored in authenticator smart card 34 and an algorithm stored in the smart card for processing the authorization key to provide the response. Optionally the smart card has been programmed to associate a particular authorization key with service provider 41, and to use the particular authorization key to provide the response. Optionally, the challenge comprises instructions that instruct the smart card to use a particular authentication key of the plurality of authentication keys to provide the response. In a block 110 the authenticator smart card transmits the response to smartphone 21. In a block 111 smartphone 21 optionally forwards the response to computer system 31 via a data channel of the mobile network to which the smartphone is connected.

In a block 112 computer system 31 processes the response it received from smartphone 21 to verify if the response is a response that is expected from user 20 and a communication device that is registered with authentication system 30 as associated with user 20. In a block 113 computer system 31 transmits the result of the verification process to service provider 41. In a decision block 114 if verification is indicated as successful, and as a result the identity of user 20 is considered authenticated by authenticator system 30, in a block 115 service provider 41 provides user 20 with access. If on the other hand verification is indicated as having failed, and as a result the identity of user 20 is considered not authenticated by authenticator system 30, in a block 116 service provider 41 denies user 20 with access.

It is noted that in an embodiment of the invention, authenticator smart card 34 may, in block 109, in addition to generating a response to the challenge it receives from smartphone 21, generate a key for encrypting communication between smartphone 21 and service provider 41, which is provided to the user device. Authenticator smart card 34 may also include data in its authentication response, which computer system 31 subsequently includes or uses to derive other data that it includes in its authentication response to service provider 41, allowing service provider 41 to generate a key for encrypting communication between the service and the smartphone 21.”

Whereas in the above description computer system 31 mediates authentication of user 20 for service provider 41 and engages smartphone 21 in an authentication challenge-response procedure, in an embodiment of the invention a service provider that uses an authenticator system, similar to authenticator system 30, in accordance with an embodiment of the invention, may bypass computer system 31 and directly engage smartphone 21 in the authentication procedure. For example, authentication functionalities provided by computer system 31 may be comprised in and executed by the service provider.

It is noted that in the above description and in FIG. 1 computer system 31 may appear as a single centralized computer system. However, practice of the invention is not limited to computer system 31 being housed in a single computer or being located in a single location. Computer system 31 for example may have a distributed configuration with code and hardware components of the computer system located in different locations. For example, computer system 31 may be a distributed “cloud computer system”, and/or as noted in the previous paragraph, service provider 41 may comprise and execute some or all functionalities used in authenticating a user and computer system 31 other of the authenticating functionalities.

In some embodiments of the invention, an authenticator, similar to authenticator system 30, may be configured to authenticate a user to a service only if a user communication device being used to request access to the service is authenticated by another service or communication network to which the user device is subscribed. For example, in authentication procedure 100 it was assumed that smartphone 21 was authenticated and operating via a mobile phone network. In some embodiments of the invention, computer system 31 may authenticate user 20 if and only if smartphone 21 is authenticated by the mobile phone network or another service with which the smartphone is subscribed. The “double authentication” may operate to limit fraudulent use of stolen user communication equipment being used to access a service.

In some embodiments of the invention, authenticator smart card 34 may be programmed with a blocking algorithm which may be activated to prevent and/or enable authenticator system 30 authenticating a user of smartphone 21. The blocking algorithm may be activated by transmitting a message, such as an SMS, containing a predetermined blocking code to smartphone 21. Activation of the blocking algorithm to prevent authentication of the smartphone may be used to prevent unlawful access to service providers in the event that the smartphone is lost or stolen. The blocking algorithm may be activated to reinstate authentication of the smartphone by transmitting a message, such as an SMS, containing a predetermined unblocking code to the smartphone. Optionally the blocking and unblocking codes are the same.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. An authenticator system for authenticating identity of a user for access to each of a plurality of services provided by at least one service provider, the authenticator comprising:
a smart card having stored therein a plurality of authentication keys and comprising communication circuitry for communicating with a communication device used to communicate with the at least one service provider; and
a computer system configured to:
receive a communication from a service provider of the at least one service provider comprising a request to authenticate the user when the user operates the communication device to request access to a service provided by the service provider; and
communicate with the smart card via the communication device to engage in an authentication process to authenticate identity of the user responsive to an authentication key of the plurality of authentication keys stored in the smart card.

2. The authenticator system according to claim 1 wherein the smart card is programmed with an executable instruction set for processing the authentication key to engage in the authentication process and authenticate identity of the user.

3. The authenticator system according to claim 1 wherein the communication circuitry communicates with the communication device via a wireless communication channel.

4. The authenticator system according to claim 1 wherein the communication circuitry communicates with the communication device via a wire communication channel.

5. The authenticator system according to claim 1 wherein upon receiving the communication from the service provider with the request to authenticate the user, the computer system transmits a notice to the communication device that indicates to the user that a request has been made to authenticate the user.

6. The authenticator system according to claim 5 wherein the notice comprises a request that the user authorize the authentication process.

7. The authenticator system according to claim 6 wherein the request for authorization includes a request that the user include in a response to the request for authorization a password identifying the user.

8. The authenticator system according to claim 1 wherein the smart card is programmed with an executable instruction set to implement a blocking algorithm which may be activated to prevent or enable engaging in the authentication process to authenticate identity of the user by transmitting a communication to the communication device.

9. The authenticator system according to claim 1 wherein the communication device communicates via a mobile phone communication network.

10. The authenticator system according to claim 1 wherein the service provider comprises the computer system.

11. The authenticator system according to claim 1 wherein at least two different services are associated with different authentication keys or at least two different services are associated with a same authentication key.

12. A method of authenticating a user to each of a plurality of services provided by at least one service provider, the method comprising:
providing the user with a smart card having stored therein a plurality of authentication keys and comprising communication circuitry for communicating with a communication device that the user uses to communicate with the at least one service provider;
and communicating with the smart card to authenticate the user responsive to an authentication key of the plurality of authentication keys.
